(19) United States
(12) Patent Application Publication
(10) Pub. No.: US 2012/0147411 A1
(43) Pub. Date: Jun. 14, 2012

(54) IMAGE FORMING APPARATUS, INFORMATION PROCESSING METHOD, AND STORAGE MEDIUM

(75) Inventor: Shinya MORI, Tokyo (JP)

(73) Assignee: RICOH COMPANY, LTD., Tokyo (JP)

(21) Appl. No.: 13/308,617

(22) Filed: Dec. 1, 2011

(30) Foreign Application Priority Data
Dec. 14, 2010 (JP) 2010-277804

(51) Int. Cl. G06K 15/02

(52) U.S. Cl. 358/1.14

(57) ABSTRACT

An image forming apparatus includes a function validity information storing unit that stores function validity information including identification information of functions and configurations of the functions that are available or valid in the image forming apparatus; a receiving unit that receives identification information of requested functions to be executed on the image forming apparatus and configuration information of the requested functions from a computer; a determining unit that determines whether the requested functions are valid by examining the identification information and the configuration information of the requested functions with reference to the function validity information stored in the function validity information storing unit; and a display control unit that displays, on a display unit, an option corresponding to a valid function determined to be valid such that the option corresponding to the valid function is distinguishable from an option corresponding to an invalid function determined to be invalid.

### CROSS-REFERENCE TO RELATED APPLICATION

The present application is based upon and claims the benefit of priority of Japanese Patent Application No. 2010-277804, filed on Dec. 14, 2010, the entire contents of which are incorporated herein by reference.

### BACKGROUND OF THE INVENTION

1. Field of the Invention

An aspect of this disclosure relates to an image forming apparatus, an information processing method, and a storage medium.

2. Description of the Related Art

Japanese Laid-Open Patent Publication No. 2010-157027 discloses programs (called net applications) that are installed in personal computers (PCs) connected via a network with image forming apparatuses. The net applications cause the PCs to perform process flows in collaboration with the image forming apparatuses.

In the technology disclosed in JP2010-157027, information associated with the net applications running on the PCs is sent to the image forming apparatuses via broadcasts called advertisements. More specifically, when the net applications are started, users who have started the net applications are advertised on the network. Each image forming apparatus receives the advertisements from the PCs and manages a list of users who have started the net applications on the respective PCs. In response to a command from an operator (a user), the image forming apparatus displays the list of users on an operations panel. When the operator selects the corresponding user from the list of users, a list of net applications that have been started on the PC of the selected user is downloaded into the image forming apparatus. Then, the operator can select and use one of the net applications in the list of net applications.

The above configuration enables a user to select a desired image forming apparatus from image forming apparatuses installed in, for example, an office and to use net applications on the selected image forming apparatus.

However, image forming apparatuses installed in an office do not necessarily have the same functions. For example, color image forming apparatuses and monochrome image forming apparatuses may be installed in an office. As another example, multifunction peripherals that have printing and scanning functions and printers that have only the printing function may coexist in an office.

For this reason, there may be a case where an image forming apparatus on which a net application is selected does not have a function that is used by the net application. In such a case, the user cannot obtain an expected result and needs to operate another image forming apparatus to select and execute the net application.

The above problem reduces the working efficiency of the user and may result in waste of resources such as paper.

### SUMMARY OF THE INVENTION

In an aspect of this disclosure, there is provided an image forming apparatus that includes a function validity information storing unit configured to store function validity information including identification information of functions available in the image forming apparatus and configurations of the functions that are valid in the image forming apparatus; a receiving unit configured to receive identification information of requested functions to be executed on the image forming apparatus and configuration information of the requested functions from a computer connected via a network to the image forming apparatus; a determining unit configured to determine whether the requested functions are valid by examining the identification information and the configuration information of the requested functions with reference to the function validity information stored in the function validity information storing unit; and a display control unit configured to display, on a display unit, an option corresponding to a valid function of the requested functions that is determined to be valid such that the option corresponding to the valid function is distinguishable from an option corresponding to an invalid function of the requested functions that is determined to be invalid.

### BRIEF DESCRIPTION OF THE DRAWINGS

FIG. 1 is a drawing illustrating an exemplary configuration of an information processing system according to a first embodiment;

FIG. 2 is a block diagram illustrating an exemplary hardware configuration of an image forming apparatus;

FIG. 3 is a block diagram illustrating an exemplary hardware configuration of a user terminal;

FIG. 4 is a block diagram illustrating exemplary functional configurations of a widget, a widget manager, and a provider application according to the first embodiment;

FIG. 5 is a sequence chart illustrating an exemplary process performed when a widget manager and a widget are started;

FIG. 6 is a table illustrating an exemplary configuration of a user management table;

FIG. 7 is a table illustrating exemplary widget information of a print widget;

FIG. 8 is a table illustrating exemplary widget information of a scan widget;

FIG. 9 is a sequence chart illustrating an exemplary process of entering a print job by a print widget;

FIG. 10 is a table illustrating exemplary print configuration information for a print widget;

FIG. 11 is a sequence chart illustrating an exemplary process of registering scan configuration information for a scan job performed by a scan widget;

FIG. 12 is a table illustrating exemplary scan configuration information;

FIG. 13 is a sequence chart illustrating an exemplary process of displaying a list of executable widgets;

FIG. 14 is a drawing illustrating an exemplary user selection screen;

FIG. 15 is a table illustrating an exemplary configuration of information stored in a function validity information storing unit;

FIG. 16 is a drawing illustrating an exemplary widget selection screen;

FIG. 17 is a flowchart illustrating an exemplary process of determining whether widgets are valid;

FIG. 18 is a sequence chart illustrating an exemplary process performed when a print widget is executed;

FIG. 19 is a sequence chart illustrating an exemplary process performed when a scan widget is executed;

FIG. 20 is a drawing illustrating an exemplary configuration of an information processing system according to a second embodiment;

FIG. 21 is a drawing illustrating exemplary functional configurations of a provider application and an apparatus management device according to the second embodiment; and

FIG. 22 is a sequence chart illustrating an exemplary process performed when an invalid widget is selected according to the second embodiment.

### DESCRIPTION OF THE PREFERRED EMBODIMENTS

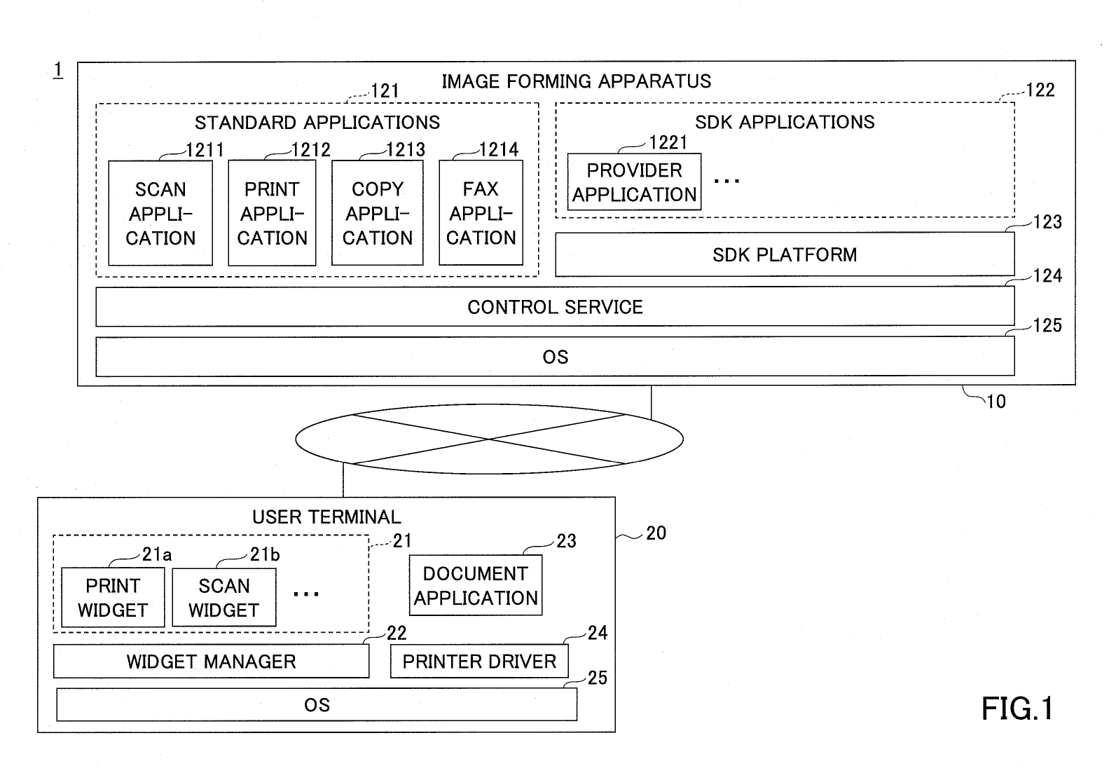

Preferred embodiments of the present invention are described below with reference to the accompanying drawings. FIG. 1 is a drawing illustrating an exemplary configuration of an information processing system 1 according to a first embodiment. As illustrated in FIG. 1, the information processing system 1 may include at least one image forming apparatus 10 and at least one user terminal 20 that are connected via a (wired or wireless) network such as a local area network (LAN) or the Internet.

The image forming apparatus 10 may be, for example, a multifunction peripheral including two or more functions such as printing, scanning, copying, and facsimile transmission and reception. Alternatively, the image forming apparatus 10 may be an apparatus such as a printer, a scanner, a copier, or a facsimile machine having one function.

The user terminal 20 may be implemented by any type of device that can store and execute a software program and has a communication function. For example, the user terminal 20 may be implemented by a desktop personal computer (PC), a notebook PC, a personal digital assistant (PDA), or a cell phone.

An exemplary software configuration of the user terminal 20 is described below. As illustrated in FIG. 1, the user terminal 20 includes a print widget 21a, a scan widget 21b, a widget manager 22, a document application 23, a printer driver 24, and an operating system (OS) 25.

The print widget 21a and the scan widget 21b are examples of application programs that are collectively called “widgets 21” (or the widget 21 in the singular form) in the present application. In recent years, simple application programs are often called widgets or gadgets. In the present application, application programs that can be easily installed and used are called the widgets 21 and the term “widget” does not limit the technical scope of the application programs. The widgets 21 perform predetermined process flows (such as workflows) by using functions of (or in collaboration with) the image forming apparatus 10.

The print widget 21a requests the image forming apparatus 10 to execute a print job for print data generated for a logical printer.

The scan widget 21b requests the image forming apparatus 10 to scan a document to obtain image data and stores the obtained image data in the user terminal 20.

The widget manager 22 interfaces communications between the widgets 21 and the image forming apparatus 10. Each of the widgets 21 may include an interface and a protocol defined by the widget manager 22. In other words, the widgets 21 are application programs that operate in cooperation with the widget manager 22.

The document application 23 is software such as a word processor or a spreadsheet for creating electronic document data that can be printed. Although the document application 23 is represented by one block in FIG. 1, the document application 23 may represent two or more application programs that can create document data of various data formats.

The printer driver 24 generates print data from document data generated by the document application 23. When a logical printer corresponding to the print widget 21a is specified as the print destination, the printer driver 24 generates an intermediate file with a file name specified as the output destination of the logical printer and outputs the print data to the intermediate file.

The OS 25 is an operating system. Software programs in the user terminal 20 run as processes or threads on the OS 25.

An exemplary software configuration of the image forming apparatus 10 is described below. As illustrated in FIG. 1, the image forming apparatus 10 may include standard applications 121, SDK applications 122, an SDK platform 123, a control service 124, and an OS 125.

The standard applications 121 are default applications installed in the image forming apparatus 10 before the factory shipment. In the example of FIG. 1, the standard applications 121 include a scan application 1211, a print application 1212, a copy application 1213, and a fax application 1214. The scan application 1211 performs a scan job. The print application 1212 performs a print job. The copy application 1213 performs a copy job. The fax application 1214 performs a facsimile transmission job and a facsimile reception job.

The control service 124 is implemented by software modules that, for example, provide upper-layer applications with functions for controlling various hardware resources. The functions, for example, include a network communication function, a scanner control function, a printer control function, and a memory management function.

The SDK applications 122 are plug-in applications that are additionally installed to expand the functions of the image forming apparatus 10 after its factory shipment. In FIG. 1, a provider application 1221 is provided as an example of the SDK applications 122. The provider application 1221 performs a process to enable operations of the widgets 21 from the image forming apparatus 10.

The SDK platform 123 provides an execution environment for the SDK applications 122. The SDK applications 122 are developed using application programming interfaces (API) provided by the SDK platform 123. For example, the SDK platform 123 provides the SDK applications 122 with a scanning function interface, a printing function interface, and a copying function interface. APIs provided by the SDK platform 123 may be made public to allow a third party to develop the SDK applications 122.

The OS 125 is an operating system. Software programs in the image forming apparatus 10 run as processes or threads on the OS 125.

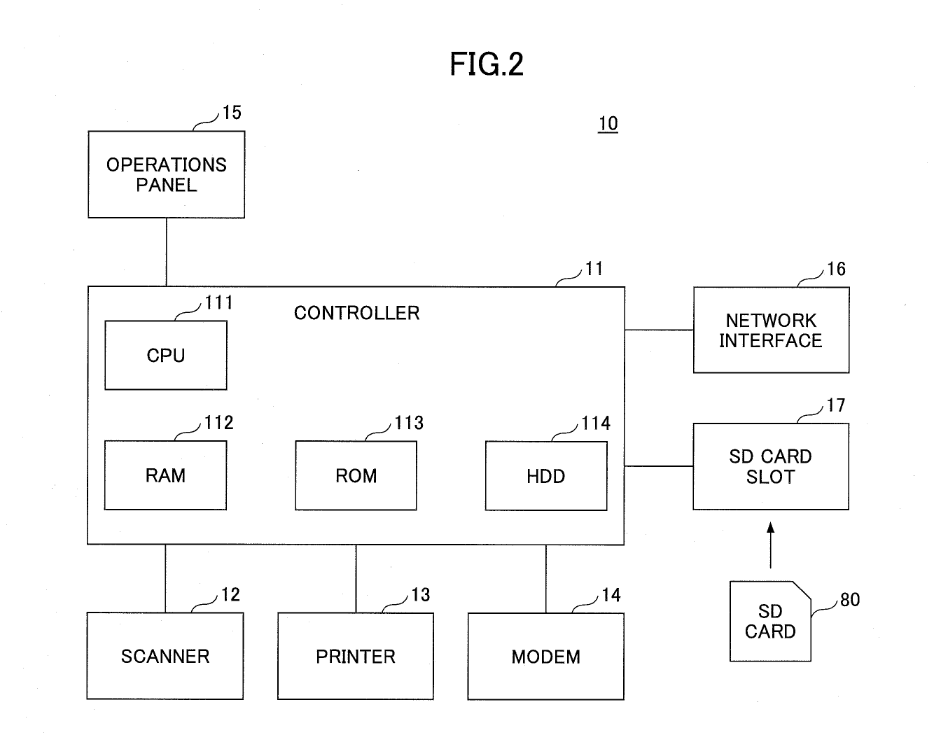

Hardware configurations of the image forming apparatus 10 and the user terminal 20 are described below. FIG. 2 is a block diagram illustrating an exemplary hardware configuration of the image forming apparatus 10. As illustrated in FIG. 2, the image forming apparatus 10 may include, as hardware components, controller 11, a scanner 12, a printer 13, a modem 14, an operations panel 15, a network interface 16, and a secure digital (SD) card slot 17.

The controller 11 includes a CPU 111, a RAM 112, a ROM 113, and an HDD 114. The ROM 113 stores, for example, programs and data used by the programs. The RAM 112 is used, for example, as a storage area into which programs are loaded and as a work area for the loaded programs. The CPU 111 executes the programs loaded into the RAM 112 to implement various functions. The HDD 114 stores, for example, programs and data used by the programs.

The scanner 12 is a hardware component for scanning a document to obtain image data. The printer 13 is a hardware component for printing print data on a recording medium such as paper. The modem 14 is a hardware component for connecting the image forming apparatus 10 to a telephone line and is used to send and receive image data for facsimile communications. The operations panel 15 is a hardware component including an input unit such as buttons for receiving user inputs and a display unit such as a liquid crystal display panel. The network interface 16 is a hardware component for connecting the image forming apparatus 10 to a (wired or wireless) network such as a LAN. The SD card slot 17 reads, for example, programs stored in a secure digital (SD) card 80. With the image forming apparatus 10 configured as described above, in addition to the programs stored in the ROM 113, programs stored in the SD card 80 can be loaded into the RAM 112 and executed. Instead of the SD card 80, any other storage medium (e.g., a CD-ROM or a universal serial bus (USB) memory) may also be used for this purpose. That is, a storage medium that can be mounted on the image forming apparatus is not limited to the SD card 80. When a storage medium other than the SD card 80 is used, the SD card slot 17 may be replaced with a hardware component corresponding to the storage medium used.

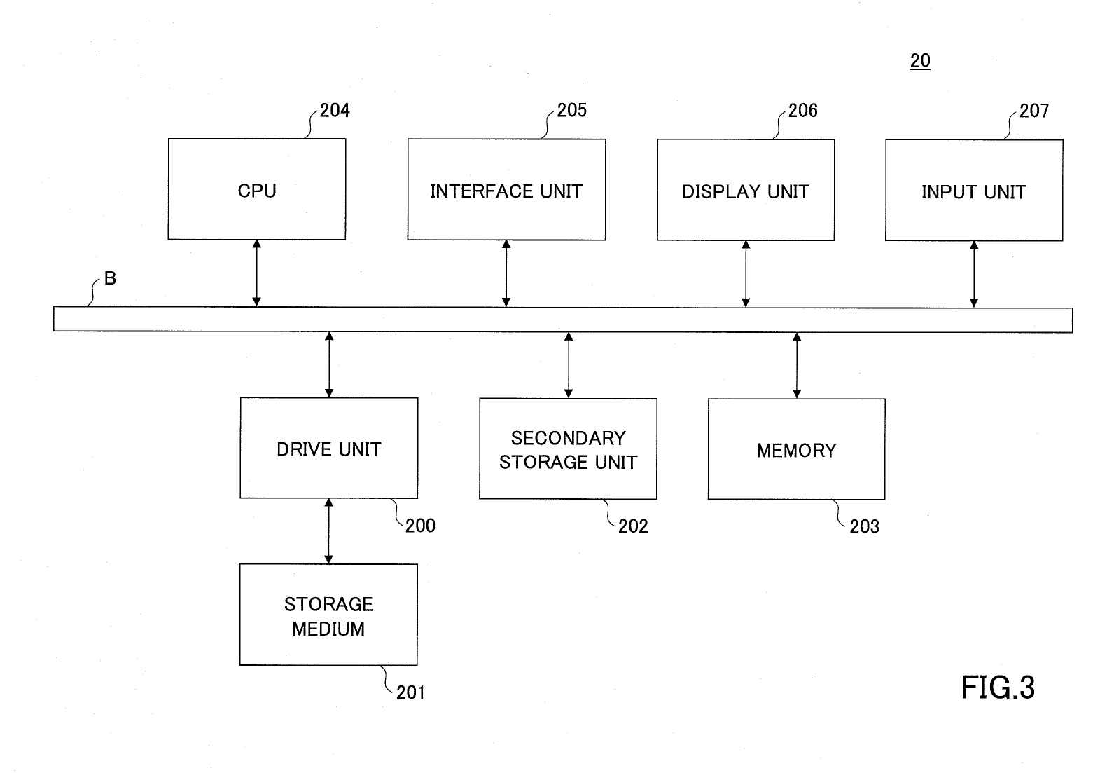

FIG. 3 is a block diagram illustrating an exemplary hardware configuration of the user terminal 20. As illustrated in FIG. 3, the user terminal 20 may include a drive unit 200, a secondary storage unit (storage device) 202, a memory 203, a CPU 204, an interface unit 205, a display unit 206, and an input unit 207 that are connected to each other via a bus B.

Programs for implementing various processes at the user terminal 20 may be provided via a storage medium 201 such as a CD-ROM or a memory card. When the storage medium 201 storing programs is mounted on the drive unit 200, the programs are read by the drive unit 200 from the storage medium 201 and are installed in the secondary storage unit 202. The programs may not necessarily be installed from the storage medium 201, but may instead be downloaded via a network from another computer. The secondary storage unit 202 stores the installed programs and other necessary files and data.

The memory 203 temporarily stores programs retrieved from the secondary storage unit 202 when the programs are executed. The CPU 204 implements functions of the user terminal 20 according to the programs temporarily stored in the memory 203. The interface unit 205 provides communication interfaces such as a network interface, a universal serial bus (USB) interface, and a wireless interface (e.g., Bluetooth interface). The display unit 206 displays, for example, graphical user interfaces (GUI) output by the programs. The input unit 207 includes, for example, a keyboard, a pointing device such as a mouse, and/or buttons for receiving user inputs.

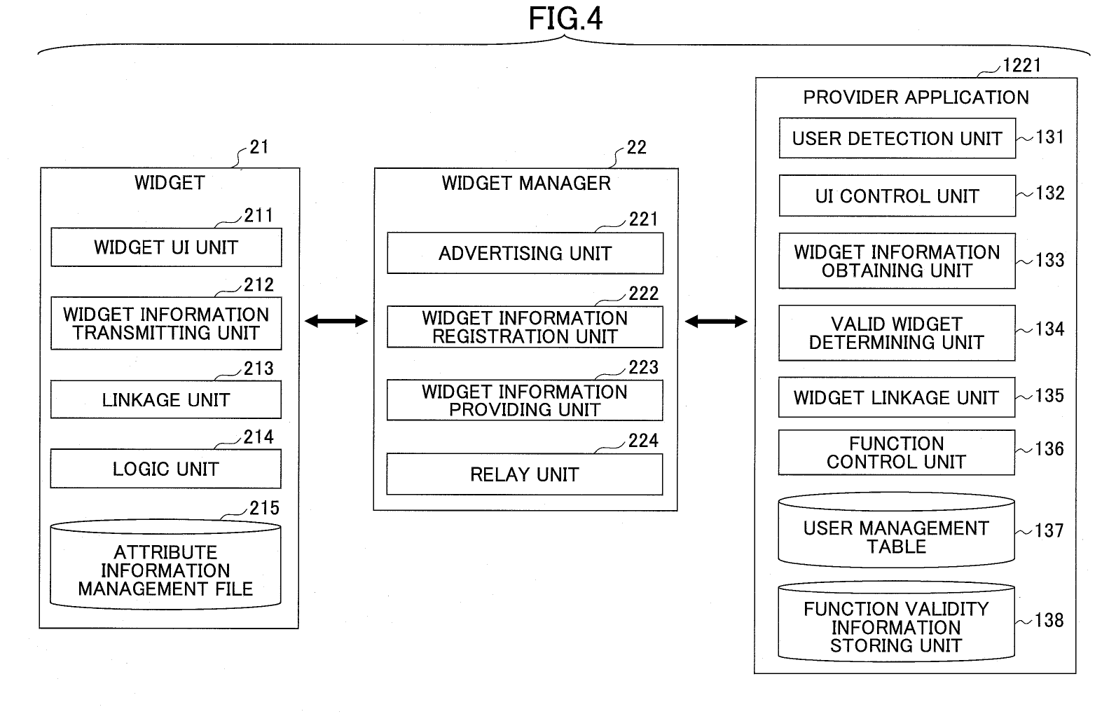

The widget 21, the widget manager 22, and the provider application 1221 are described below in more detail. FIG. 4 is a block diagram illustrating exemplary functional configurations of the widget 21, the widget manager 22, and the provider application 1221 according to the first embodiment.

As illustrated in FIG. 4, the widget 21 may include a widget UI unit 211, a widget information transmitting unit 212, a linkage unit 213, a logic unit 214, and an attribute information management file 215.

The widget UI unit 211 controls various display and input operations (or processes) related to the widget 21. The widget information transmitting unit 212 transmits a widget information registration request requesting registration of widget information (attribute information of the widget 21) to the widget manager 22 when the widget 21 is started. The widget information includes identification information (hereafter called linked function identifiers) of functions (hereafter called linked functions) of the image forming apparatus 10 which are used by the widget 21. The linked functions are functions that need to be included in the image forming apparatus 10 that collaborates with the widget 21. In other words, the linked functions are functions that the widget 21 requests the image forming apparatus 10 to execute.

The linkage unit 213 controls communications (e.g., transmission and reception of information) for collaboration with the provider application 1221. The attribute information management file 215 contains attribute information of the widget 21. The attribute information includes configuration information of the widget 21. The configuration information includes parameters that define a behavior of the widget 21 or a job performed by the widget 21. The logic unit 214 implements functions unique to the widget 21. For example, the logic unit 214 of the print widget 21a performs a process for requesting the image forming apparatus 10 to execute a print job for print data generated for a logical printer. Meanwhile, the logic unit 214 of the scan widget 21b performs a process for storing scanned image data.

In the descriptions below, “a” may be attached to the end of the reference numbers of the components of the print widget 21a and “b” may be attached to the end of the reference numbers of the components of the scan widget 21b to distinguish between them. For example, the logic unit 214 of the print widget 21a may be expressed as “logic unit 214a”.

The widget manager 22 may include an advertising unit 221, a widget information registration unit 222, a widget information providing unit 223, and relay unit 224.

The advertising unit 221 advertises (broadcasts or multicasts), for example, a user ID of a logged-in user who has logged into the user terminal 20 via the network when the widget manager 22 is started. The advertisement is issued for each user (for each user ID). Accordingly, the advertisement issued by the advertising unit 221 is used to report to the image forming apparatus 10 new entry of a user allowed to use a widget 21.

The widget information registration unit 222 receives the widget information registration request including the widget information from the widget 21 and stores the widget information in, for example, the secondary storage unit 202.

The widget information providing unit 223, in response to a request from the image forming apparatus 10, provides (transmits) the widget information stored in the secondary storage unit 202 to the image forming apparatus 10. The relay unit 224 relays communications between the widget 21 and the provider application 1221.

The provider application 1221 may include a user detection unit 131, a UI control unit 132, a widget information obtaining unit 133, a valid widget determining unit 134, a widget linkage unit 135, a function control unit 136, a user management table 137, and a function validity information storing unit 138.

The user detection unit 131 detects a user (or the user terminal 20) allowed to use the widget 21 based on the advertisement issued by the widget manager 22 and registers, for example, a user ID included in the advertisement in the user management table 137. The user management table 137 is used to manage a list of users who are allowed to use the widgets 21 on the network and may be stored, for example, in the HDD 114.

The UI control unit 132 receives user inputs for operating the widgets 21. Thus, although the widgets 21 are stored in the user terminal 20, they can also be operated by using the operations panel 15 of the image forming apparatus 10.

The widget information obtaining unit 133 obtains, from the widget manager 22, the widget information of the widgets 21 that belong to a user (user ID) selected from the users (user IDs) registered in the user management table 137.

The valid widget determining unit 134 determines, using the function validity information storing unit 138, whether each of the widgets 21 whose widget information has been obtained by the widget information obtaining unit 133 is valid in the image forming apparatus 10. When the image forming apparatus 10 includes all linked functions requested by a widget 21 (functions that the widget 21 uses), the widget 21 is determined to be valid.

The function validity information storing unit 138 stores information indicating functions that are valid (or available) in the image forming apparatus 10. The function validity information storing unit 138 may be implemented by, for example, a storage area of the HDD 114.

The widget linkage unit 135 controls communications with the widget manager 22. The function control unit 136 controls execution of functions requested by the widgets 21. Actual processes for providing the functions are performed by the standard applications 121 and the SDK applications 122 other than the provider application 1221.

Exemplary processes in the information processing system 1 are described below. Before using a widget 21, the user starts the widget manager 22 on the user terminal 20 and starts the widget 21. An exemplary process performed when the widget manager 22 and the widget 21 are started is described below.

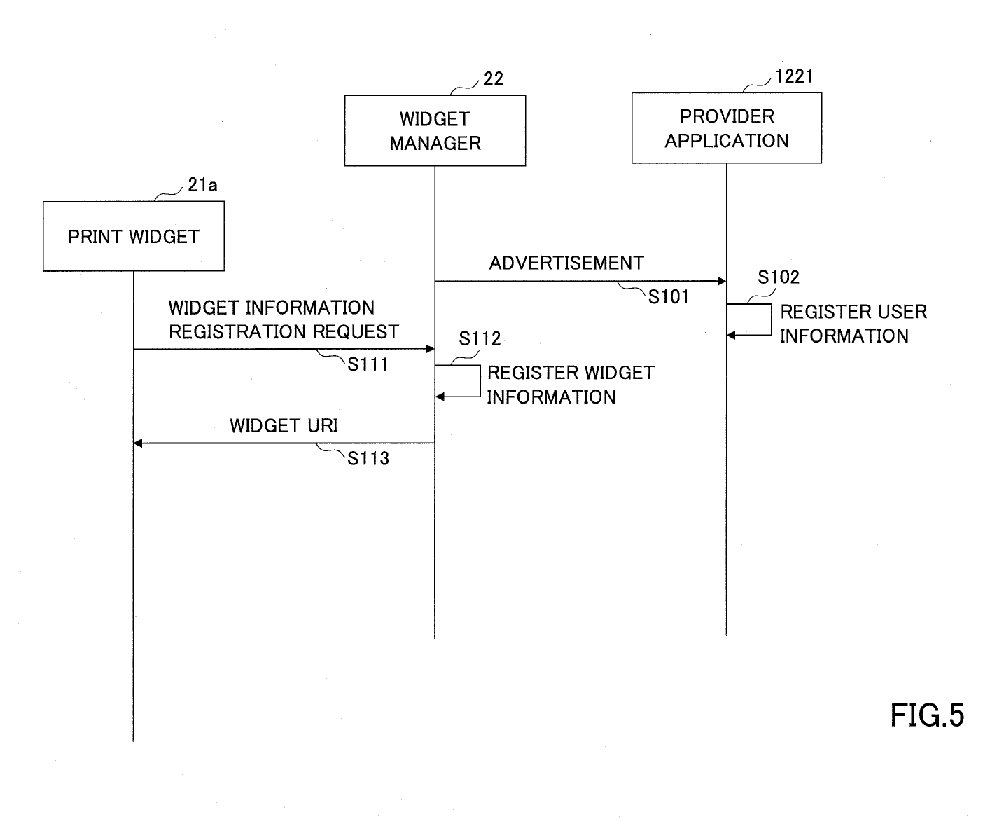

FIG. 5 is a sequence chart illustrating an exemplary process performed when the widget manager 22 and the print widget 21a are started.

When the widget manager 22 is started by the user or automatically, the advertising unit 221 of the widget manager 22 transmits (or issues) an advertisement including a user ID of a logged-in user and a widget manager URI (uniform resource identifier) via the network (S101). The widget manager URI is an URI that is unique to the widget manager 22. In this embodiment, it is assumed that one widget manager 22 is started on one user terminal 20. Therefore, the widget manager URI also functions as identification information of the user terminal 20.

When receiving the advertisement, the user detection unit 131 of each image forming apparatus 10 registers the user ID and the widget manager URI (user information) contained in the advertisement in the user management table 137 (S102).

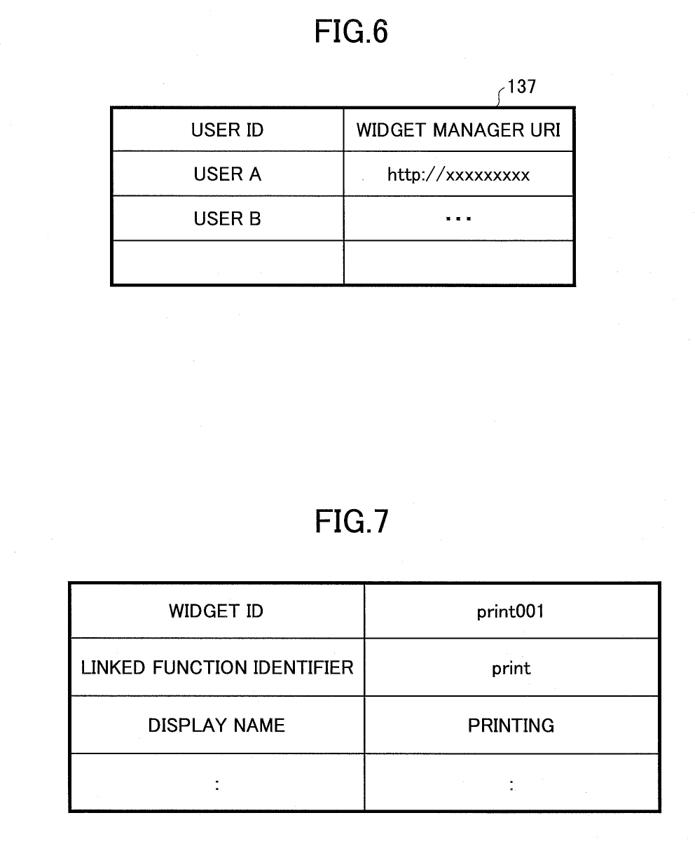

FIG. 6 illustrates an exemplary configuration of the user management table 137. As illustrated in FIG. 6, the user management table 137 stores user IDs in association with widget manager URIs.

When multiple users start the widget managers on their respective user terminals 20, multiple records for those users are registered in the user management table 137 of the image forming apparatus 10.

After the widget manager 22 is started, the user starts the print widget 21a or the scan widget 21b on the user terminal 20. In this exemplary process, it is assumed that the user starts the print widget 21a.

When the print widget 21a is started, the widget information transmitting unit 212a of the print widget 21a transmits a widget information registration request requesting registration of the widget information of the print widget 21a to the widget manager 22 (S111).

FIG. 7 illustrates exemplary widget information of the print widget 21a. As illustrated in FIG. 7, the widget information of the print widget 21a includes a widget ID, a linked function identifier, and a display name.

The widget ID is identification information for uniquely identifying the print widget 21a. The linked function identifier is identification information of a function that is used by the print widget 21a. The print widget 21a causes (or requests) the image forming apparatus 10 to perform printing, i.e., uses the printing function of the image forming apparatus 10. Therefore, in this example, “print” indicating the printing function is specified as the linked function identifier of the print widget 21a. The display name is a character string to be displayed as the name of the print widget 21a. The widget information is obtained, for example, from the attribute information management file 215a.

The widget information transmitted from the widget information transmitting unit 212a of the print widget 21a is received by the widget information registration unit 222 of the widget manager 22. The widget information registration unit 222 generates a URI including the widget ID in the received widget information and stores (or registers) the widget information in the secondary storage unit 202 in association with the generated URI (S112). The URI is called a “widget URI” and is generated for each widget 21 when its widget information is registered. The widget URI may be generated, for example, by attaching the widget ID to the end of the widget manager URI. As described above, the widget manager URI is unique to the widget manager 22 (i.e., to each user terminal 20). Therefore, if the print widgets 21a are started on multiple user terminals 20, different widget URIs are generated for the print widgets 21a on the respective user terminals 20. This indicates that it is possible to identify a print widget 21a (of a user terminal 20) on the network based on the widget URI.

Next, the widget information registration unit 222 transmits the widget URI generated in step S112 to the widget information transmitting unit 212a of the print widget 21a (S113). The widget information transmitting unit 212a stores (or records) the widget URI in the memory 203 as the widget URI for the print widget 21a. Also, the widget UI unit 211a displays an icon of the started print widget 21a on the display unit 206 of the user terminal 20.

Through the above process, the print widget 21a is registered in the widget manager 22.

Although the print widget 21a is used in the exemplary process described above, a similar process (particularly steps S111 through S113 in FIG. 5) may be performed when the scan widget 21b (or any other widget 21) is started. Since one widget manager 22 is started on one user terminal 20, it is not necessary to repeat steps S101 and S102 in FIG. 5 every time a widget 21 is started.

For example, when the scan widget 21b is started, the widget information transmitting unit 212b of the scan widget 21b transmits the widget information of the scan widget 21b to the widget manager 22 (S111).

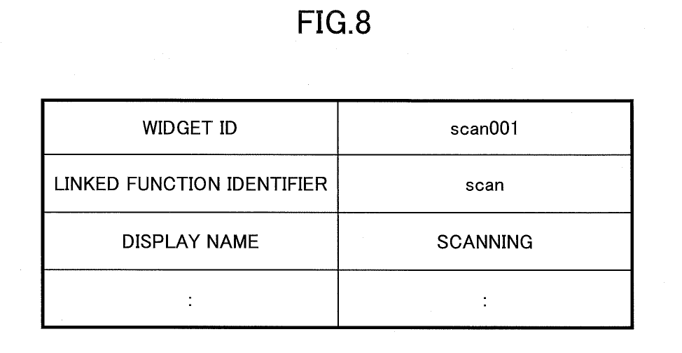

FIG. 8 illustrates exemplary widget information of the scan widget 21b. As illustrated in FIG. 8, items constituting the widget information of the scan widget 21b are the same as those of the widget information of the print widget 21a in FIG. 7, except that their values are different.

In FIG. 8, the widget ID is identification information of the scan widget 21b. Since the scan widget 21b uses the scanning function of the image forming apparatus 10, “scan” indicating the scanning function is specified as the linked function identifier of the scan widget 21b. The display name is a character string to be displayed as the name of the scan widget 21b.

When receiving the widget information as illustrated in FIG. 8, the widget manager 22 generates a widget URI for the scan widget 21b and transmits the widget URI to the scan widget 21b.

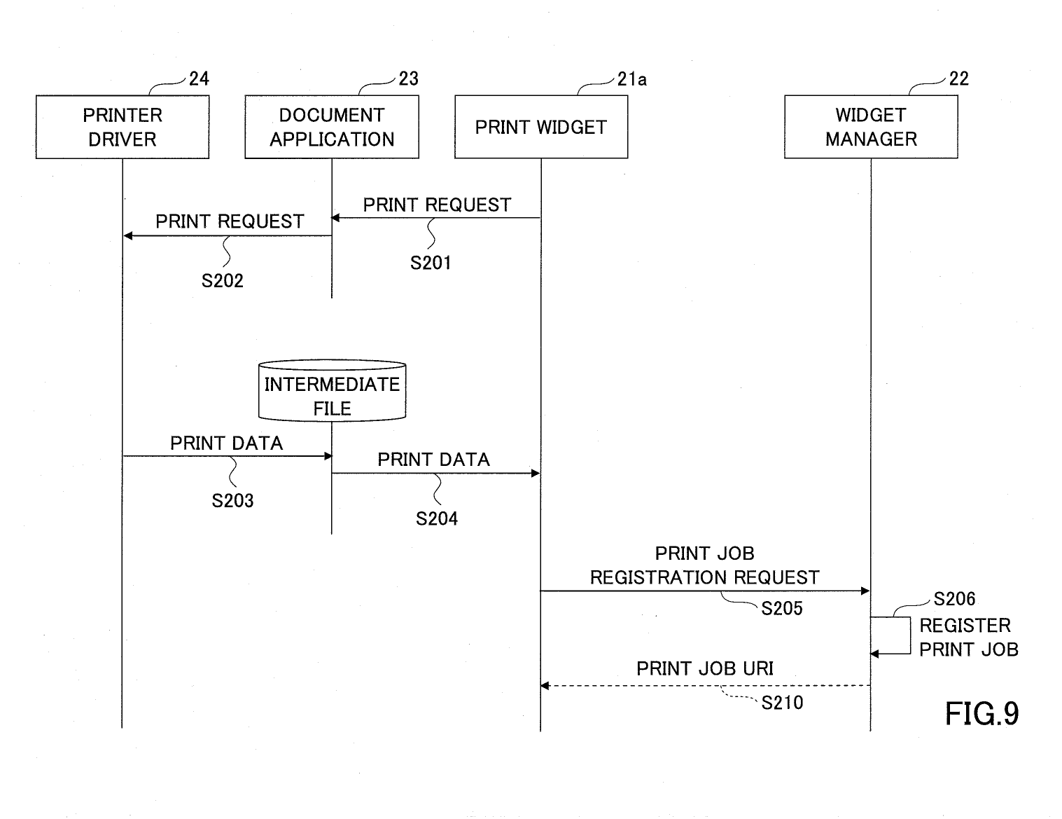

Next, an exemplary process of entering a print job by the print widget 21a is described. FIG. 9 is a sequence chart illustrating an exemplary process of entering a print job by the print widget 21a.

For example, when an icon of a document file to be printed is dragged and dropped on the icon of the print widget 21a, the logic unit 214a of the print widget 21a inputs a command, which is a print request to the document application 23, to the OS 25 (S201). In this case, the file name of the dragged-and-dropped document file is specified as an argument of the command. As a result, the document application 23 is started in the background. When started, the document application 23 inputs a print request for the document file to the printer driver 24 (S202). In response to the print request, the printer driver 24 generates print data (e.g., page description language (PDL) data) of the document file. When a logical printer corresponding to the print widget 21a is specified as the print destination, the printer driver 24 generates an intermediate file with a predetermined file name that is specified as the output destination of the logical printer and outputs the print data to the intermediate file (S203).

Meanwhile, after the print widget 21a is started, the logic unit 214a waits for generation of the intermediate file with the predetermined file name. More specifically, the print widget 21a “polls” (i.e., checks the presence of) a file with a predetermined file name in a predetermined folder to determine whether an intermediate file is generated. When the generation of the intermediate file is detected, the print widget 21a reads the print data from the intermediate file (S204).

Next, the linkage unit 213a transmits a print job registration request for requesting registration of a print job to the widget manager 22 (S205). The print job registration request includes print configuration information recorded, for example, in the attribute information management file 215a and the print data obtained from the intermediate file. Also, the widget URI for the print widget 21a is specified in the print job registration request.

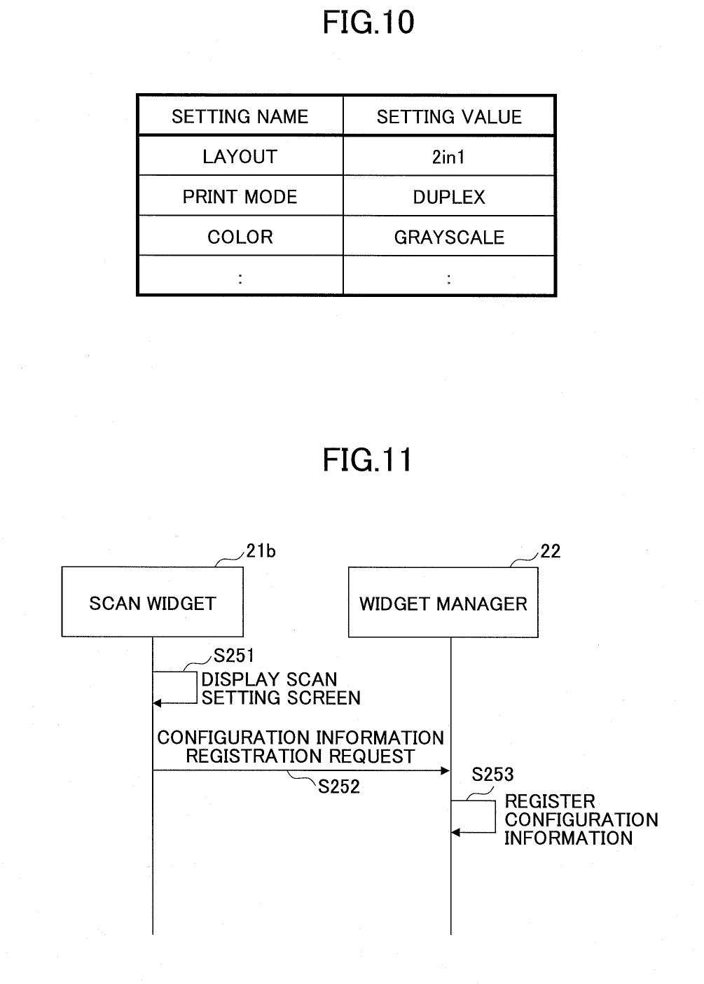

FIG. 10 illustrates exemplary print configuration information for the print widget 21a. As illustrated in FIG. 10, the print configuration information includes setting names and setting values associated with each other. The setting names are the names of settings (or parameters) constituting the print configuration information. The setting values are values of the settings indicated by the corresponding setting names. In the example of FIG. 10, “2in1” is specified for a “layout” setting, “duplex” is specified for a “print mode” setting, and “grayscale” is specified for a “color” setting. The “layout” setting specifies the layout of images (or pages) on a recording medium (e.g., paper). Here, “2in1” indicates that two pages are laid out on one side of the recording medium. The “print mode” setting specifies whether duplex printing or single-side printing is performed. The “color” setting specifies the print color mode such as “full color” or “grayscale.

The print job registration request transmitted from the linkage unit 213a of the print widget 21a is received by the widget information registration unit 222 of the widget manager 22. The widget information registration unit 222 generates a URI (print job URI) for identifying the print job, registration of which is requested by the print job registration request, based on the widget URI specified in the print job registration request; and records the print job (i.e., the print data and the print configuration information) in the secondary storage unit 202 in association with the generated print job URI (S206). The print job URI may be generated, for example, by attaching an identifier unique to the print job to the end of the widget URI. Next, the widget information registration unit 222 transmits the print job URI to the linkage unit 213a of the print widget 21a (S210).

After the print job is registered, the print widget 21a resumes polling the intermediate file. If an icon of another document file is dragged and dropped on the icon of the print widget 21a, a print job for the document file is also registered in the widget manager 22. Accordingly, two or more print jobs may be registered for one print widget 21a in one widget manager 22. In this case, the widget manager 22 generates multiple print job URIs based on one widget URI and records the print jobs in association with the print job URIs.

Next, an exemplary process of registering scan configuration information for a scan job by the scan widget 22b is described. This registration process corresponds to the process of entering a print job performed by the print widget 21a. However, unlike the process of entering a print job, a scan job is entered at the image forming apparatus 10 because it is necessary to set a document on the image forming apparatus 10 before entering the scan job. In other words, the scan widget 22b does not enter the scan job itself, but registers scan configuration information (configuration information for the scan job) in the widget manager 22.

FIG. 11 is a sequence chart illustrating an exemplary process of registering scan configuration information for a scan job performed by the scan widget 21b.

When, for example, the icon of the scan widget 21b displayed on the display unit 206 by the widget UI unit 211b is selected (clicked, double-clicked, etc.), the widget UI unit 211b displays a screen (hereafter called a scan setting screen) for setting the scan configuration information on the display unit 206 (S251). The scan setting screen may be displayed with default values specified for the scan configuration information. The default values may be stored in the attribute information management file 215b.

When the scan configuration information is specified on the scan setting screen and a command indicating the completion of the specification is entered, the logic unit 214b of the scan widget 21b transmits a scan configuration information registration request to the widget manager 22 (S252). The scan configuration information registration request includes the specified scan configuration information and the widget URI of the scan widget 21b.

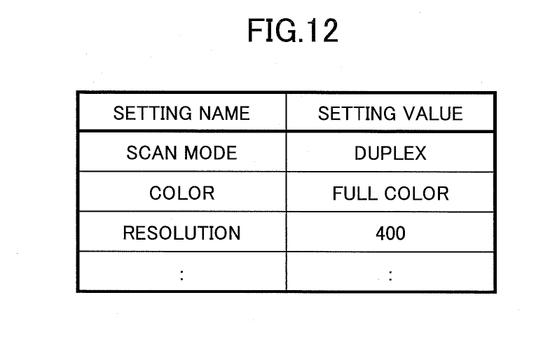

FIG. 12 illustrates exemplary scan configuration information. As illustrated in FIG. 12, the scan configuration information includes setting names and setting values associated with each other. The setting names are the names of settings (or parameters) constituting the scan configuration information. The setting values are values of the settings indicated by the corresponding setting names. In the example of FIG. 12, “duplex” is specified for a “scan mode” setting, “full color” is specified for a “color” setting, and “400” (dpi) is specified for a “resolution” setting. The “scan mode” setting specifies whether one or two sides of a document are scanned. The “color” setting specifies the scan color mode such as “full color” or “grayscale. The “resolution” setting specifies the resolution at which a document is scanned.

The scan configuration information registration request transmitted in step 5252 from the logic unit 214b of the scan widget 21b is received by the widget information registration unit 222 of the widget manager 22. The widget information registration unit 222 stores the scan configuration information in, for example, the secondary storage unit 202 in association with the widget URI specified in the received scan configuration information registration request (S253). As a result, the scan configuration information for the scan job of the scan widget 22b is registered in the widget manager 22.

After entering a print job in the widget manager 22 via the print widget 21a or registering scan configuration information for a scan job in the widget manager 22 via the scan widget 22b, the user moves to a location where the image forming apparatus 10 is installed to execute the print job or the scan job. Here, when multiple image forming apparatuses 10 are connected to the network, the same advertisement is received by the image forming apparatuses 10 and information in the advertisement is registered in the user management tables 137 of the respective image forming apparatuses 10. In this case, the user can execute the print job or the scan job on any one of the image forming apparatuses 10 that include a printing function or a scanning function.

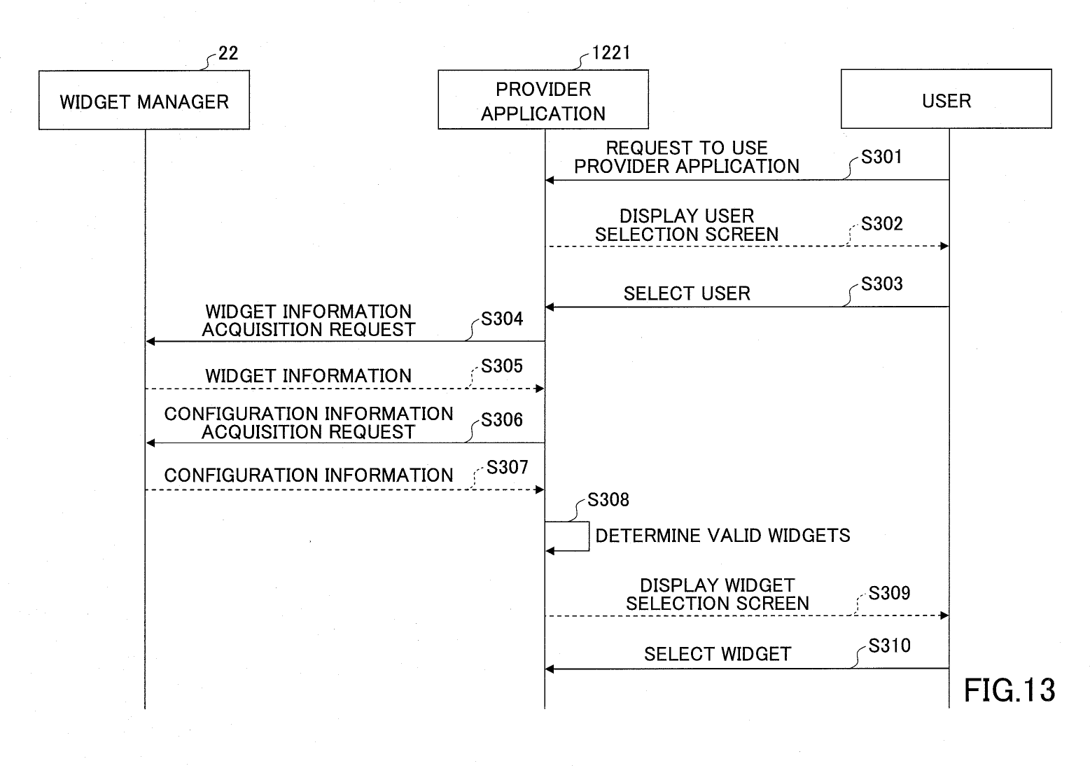

Next, a process performed according to user operations at the image forming apparatus 10 is described. FIG. 13 is a sequence chart illustrating a process of displaying a list of executable widgets.

When the user inputs a request (or command) to use the provider application 1221 (or widgets 21) via the operations panel 15 of a selected image forming apparatus (that is being operated by the user) (S301), the UI control unit 132 of the provider application 1221 displays a user selection screen on the operations panel 15 based on information registered in the user management table 137 (S302).

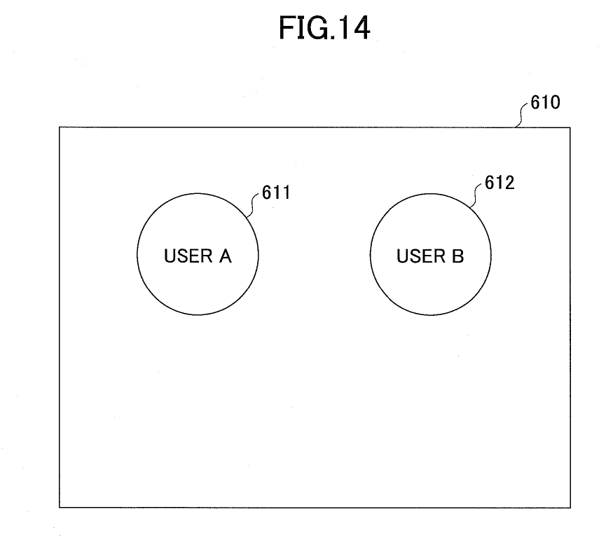

FIG. 14 illustrates an exemplary user selection screen 610. The user selection screen 610 includes buttons for respective user IDs. In this example, a button 611 for user A and a button 612 for user B are displayed on the user selection screen 610.

On the user selection screen 610, the user selects and presses one of the buttons corresponding to its own user ID (S303). When the button is pressed, the widget information obtaining unit 133 retrieves from the user management table 137 a widget manager URI corresponding to the user ID associated with the pressed button.

Next, the widget information obtaining unit 133 transmits a widget information acquisition request to the retrieved widget manager URI (S304). The widget information acquisition request is received by the widget information providing unit 223 of the widget manager 22 of the user terminal 20 corresponding to the user ID. In response, the widget information providing unit 223 obtains sets of widget information recorded in the secondary storage unit 202 and transmits the sets of widget information to the provider application 1221 (S305). For example, assuming that one print widget 21a and one scan widget 21b have been started on the user terminal 20, the widget information providing unit 223 transmits the widget information of the print widget 21a and the widget information of the scan widget 21b to the provider application 1221. Here, the corresponding widget URIs are attached to the sets of widget information transmitted by the widget information providing unit 223 to the provider application 1221. The UI control unit 132 of the provider application 1221 stores the sets of widget information received from the widget manager 22 in the RAM 112.

Next, the valid widget determining unit 134 transmits a configuration information acquisition request, which requests configuration information of the widgets 21 corresponding to the widget URIs attached to the sets of widget information, to the widget manager 22 corresponding to the widget URIs (S306). The configuration information is obtained to determine how the functions of the image forming apparatus 10 are to be used by the widgets 21.

The configuration information acquisition request is received by the relay unit 224 of the widget manager 22. In response, the relay unit 224 transmits, to the provider application 1221, the configuration information stored in the secondary storage unit 202 in association with the widget URIs specified in the configuration information acquisition request (S307). Here, configuration information (print configuration information) of the print widget 21a is stored for each print job, instead of for each print widget 21a. In other words, print configuration information is stored in association with the print job URI of each print job instead of the widget URI of the print widget 21a. Therefore, in step S307, configuration information of the print widget 21a is not transmitted to the provider application 1221. Meanwhile, configuration information (scan configuration information) of the scan widget 21b is stored in association with the widget URI of the scan widget 21b. Therefore, in step S307, configuration information of the scan widget 21b is transmitted to the provider application 1221.

Alternatively, configuration information of the widget(s) 21 may be transmitted to the provider application 1221 together with the widget information. In this case, steps S306 and S307 may be omitted.

When receiving the configuration information, the valid widget determining unit 134 determines whether the widgets 21 are valid in the selected image forming apparatus 10 by examining the widget information received in step S305 and the configuration information received in step S307 with reference to the information stored in the function validity information storing unit 138 (S308).

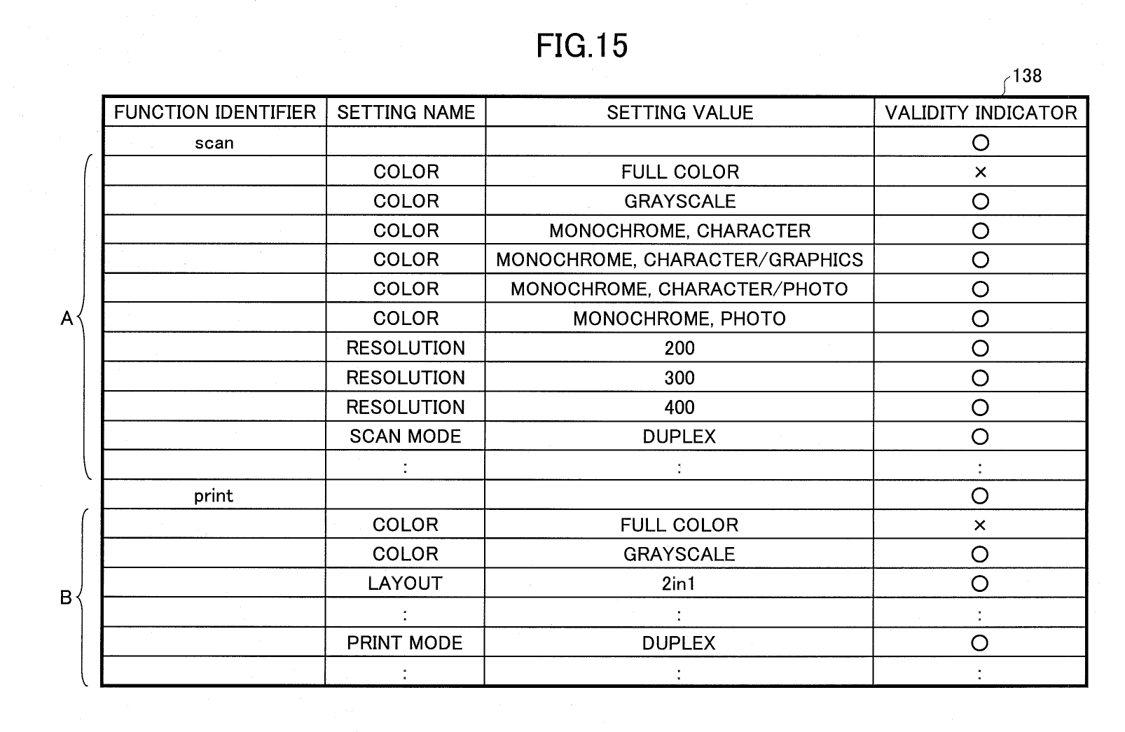

FIG. 15 illustrates an exemplary configuration of information (function validity information) stored in the function validity information storing unit 138. As illustrated in FIG. 15, the function validity information includes function identifiers, setting names, setting values, and validity indicators (validity information). The validity indicators are provided for the respective function identifiers and the respective combinations of the setting names and the setting values (i.e., configurations).

The function identifiers are identification information of functions of the image forming apparatus 10. In this example, the function validity information includes a function identifier “scan” indicating the scanning function and a function identifier “print” indicating the printing function. A validity indicator specified for a function identifier indicates whether the corresponding function (the scanning function or the printing function) is valid (available). In other words, a validity indicator specified for a function identifier indicates whether the image forming apparatus 10 includes the corresponding function. In FIG. 15, “O” indicates that the function is valid and “X” indicates that the function is invalid.

The setting names are the names of settings (or parameters) related to a function indicated by the corresponding function identifier. The setting values are values of the settings indicated by the corresponding setting names. A validity indicator specified for a combination of a setting name and a setting value indicates whether the setting value is valid for the setting indicated by the setting name. In other words, a validity indicator specified for a combination of a setting name and a setting value indicates whether the setting value can be specified for the setting indicated by the setting name. “O” indicates that the combination is valid and “X” indicates that the combination is invalid.

In FIG. 15, a row (or record) including a function identifier (and a validity indicator) is followed by rows (records) including combinations of setting names and setting values related to the function indicated by the function identifier and validity indicators for the combinations. Accordingly, records in a range indicated by “A” in FIG. 15 indicate the validity (or availability) of the combinations of setting names and setting values related to the scanning function; and records in a range indicated by “B” in FIG. 15 indicate the validity (or availability) of the combinations of setting names and setting values related to the printing function.

In the example of FIG. 15, the function validity information stored in the function validity information storing unit 138 includes even invalid combinations of setting names and setting values. Alternatively, the function validity information may include only valid combinations of setting names and setting values.

In step S308 described above, the valid widget determining unit 134 determines whether the widgets 21 are valid in the selected image forming apparatus 10 using the function validity information stored in the function validity information storing unit 138 as illustrated in FIG. 15. Details of step S308 are described later.

After step S308, based on the widget information of the widgets 21 that have been determined to be valid, the UI control unit 132 of the provider application 1221 displays a screen (widget selection screen) including options (e.g., buttons, icons, or any other types of objects) representing the valid widgets 21 on the operations panel 15 (S309).

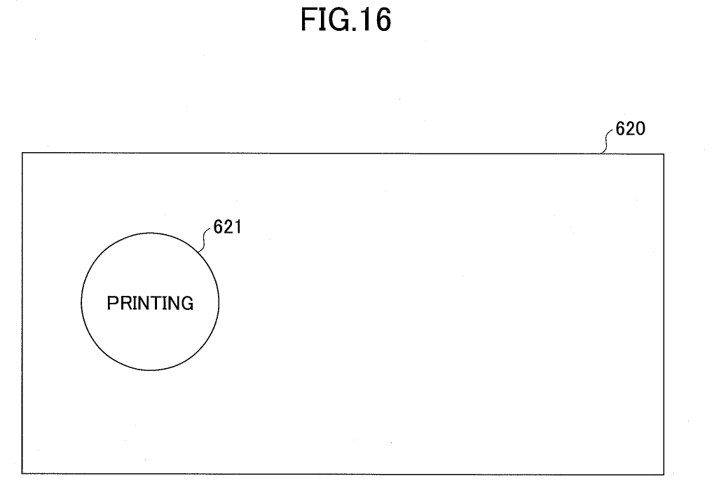

FIG. 16 illustrates an exemplary widget selection screen 620. On the widget selection screen 620, a button 621 (an option) corresponding to the print widget 21a is displayed. Accordingly, in FIG. 16, it is assumed that the print widget 21a has been determined to be valid and the scan widget 21b has been determined to be invalid in the selected image forming apparatus 10. If the scan widget 21b has been determined to be valid, a button (or option) corresponding to the scan widget 21b is also displayed on the widget selection screen 620.

Thus, only buttons (or options) corresponding to the widgets 21 that can properly collaborate with the selected image forming apparatus 10 are displayed on the widget selection screen 620. This in turn enables the user to determine whether widgets 21 can provide desired results before executing the widgets 21.

Next, the user selects one of the buttons displayed on the widget selection screen 620 to execute the widget 21 corresponding to the selected button (S310).

Alternatively, the UI control unit 132 may be configured to also display, on the widget selection screen 620, buttons (hereafter called “invalid buttons”) corresponding to invalid widgets 21 that have been determined to be invalid. In this case, the UI control unit 132 may display invalid buttons in a manner different from valid buttons corresponding to valid widgets 21. For example, invalid buttons may be dimmed (or grayed) and made unavailable (or not selectable). This enables the user to distinguish between valid widgets 21 and invalid widgets 21 on the widget selection screen 620.

Steps S304 through S308 may not necessarily be performed each time a button (or a user) is selected on the user selection screen 610. For example, once steps S304 through S308 are performed for a user, the widget information received in step S305 and the configuration information received in step S307 may be stored in the RAM 112 or the HDD 114 in association with the determination results obtained in step S308. Then, when the same user is selected on the user selection screen 610 at a later time, the widget selection screen 620 may be displayed based on the widget information and the determination results stored in the RAM 112 or the HDD 114. In this case, steps S304 through S308 may be performed periodically to update the widget information, the configuration information, and the determination results stored in the RAM 112 or the HDD 114. For example, if a new print job of the print widget 21a is entered or the scan configuration information of the scan widget 21b registered in the widget manager 22 is updated at the user terminal 20, the widget information or the configuration information stored in the image forming apparatus 10 may become inconsistent with the up-to-date widget information or configuration information. Periodically performing steps S304 through S308 makes it possible to prevent such a problem.

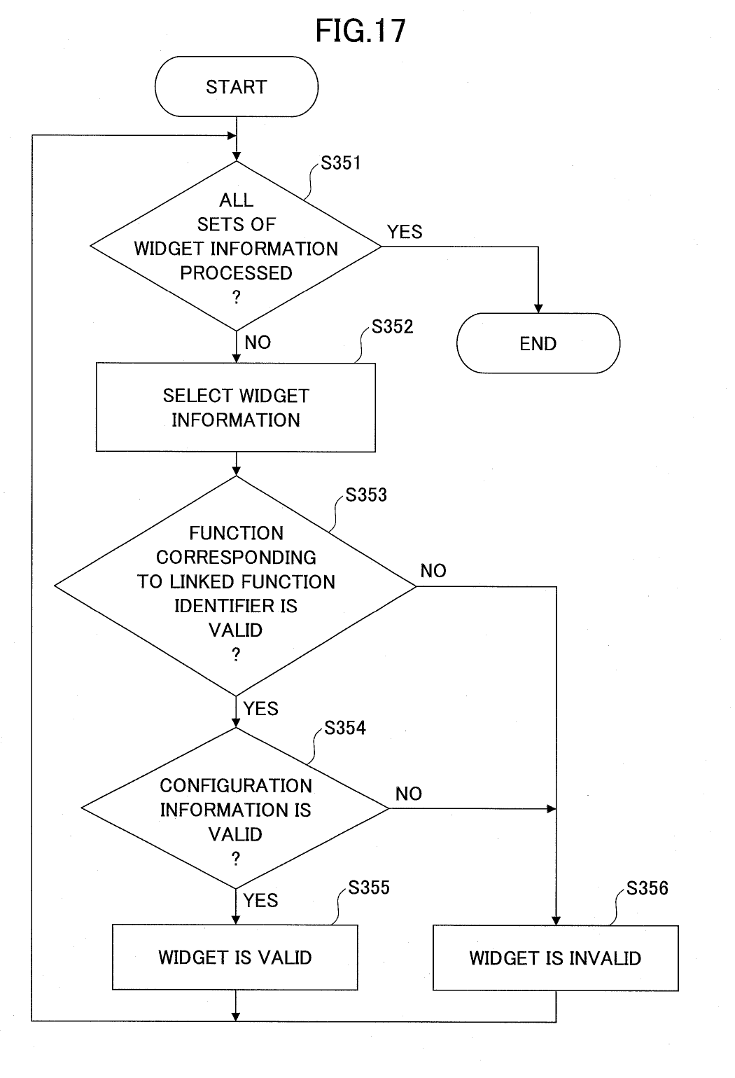

Details of step S308 are described below. FIG. 17 is a flowchart illustrating an exemplary process (widget validity determination process) of determining whether widgets 21 are valid.

In step S351 of FIG. 17, the valid widget determining unit 134 determines whether all sets of widget information received in step S305 of FIG. 13 have been processed, i.e., whether steps S352 through S356 are performed for all the sets of widget information. If there is one or more remaining sets of widget information that have not been processed (NO in S351), the valid widget determining unit 134 selects one of the remaining sets of widget information as target widget information (S352).

Next, the valid widget determining unit 134 determines whether a function corresponding to a linked function identifier in the target widget information is valid (or available) by referring to the function validity information stored in the function validity information storing unit 138 (S353). More specifically, the valid widget determining unit 134 refers to a record in the function validity information that includes a function identifier corresponding to the linked function identifier and refers to the validity indicator in the record.

If the function corresponding to the linked function identifier is valid (YES in S353), the valid widget determining unit 134 determines whether the configuration information (received in step S307 of FIG. 13) corresponding to the target widget information is valid by referring to the function validity information stored in the function validity information storing unit 138 (S354). More specifically, the valid widget determining unit 134 refers to records in the function validity information that include combinations of setting names and setting values corresponding to the combinations of setting names and setting values in the configuration information, and refers to the validity indicators in the records. If all the combinations of setting names and setting values in the configuration information are valid, the configuration information is determined to be valid. Meanwhile, if one or more of the combinations of setting names and setting values in the configuration information are invalid, the configuration information is determined to be invalid.

If the configuration information is valid (YES in S354), the valid widget determining unit 134 determines that the widget 21 corresponding to the target widget information is valid in the selected image forming apparatus 10 (S355).

Meanwhile, when the function corresponding to the linked function identifier in the target widget information is invalid (NO in S353) or the configuration information is invalid (NO in S354), the valid widget determining unit 134 determines that the widget 21 corresponding to the target widget information is invalid in the selected image forming apparatus 10 (S356).

When all the sets of widget information received in step S305 of FIG. 13 are processed (YES in S351), the process is terminated.

An exemplary case of step S308 is described based on FIGS. 7, 8, 12, and 15. In FIG. 15, the validity indicator specified for the function identifier “print” corresponding to the linked function identifier “print” of the print widget 21a is “O”. Therefore, the print widget 21a is determined to be valid.

Also, the validity indicator specified for the function identifier “scan” corresponding to the linked function identifier “scan” of the scan widget 21b is “O”. However, while “full color” is specified for the “color” setting in the scan configuration information of FIG. 12, the combination of the setting name “color” and the setting value “full color” is invalid (X) as illustrated in FIG. 15. Therefore, the scan widget 21b is determined to be invalid.

After a widget 21 (or the corresponding button) is selected on the widget selection screen 620 in step S310 of FIG. 13, a process corresponding to the selected widget 21 (the print widget 21a or the scan widget 21b) is performed. Below, processes performed when the print widget 21a and the scan widget 21b are selected are described separately.

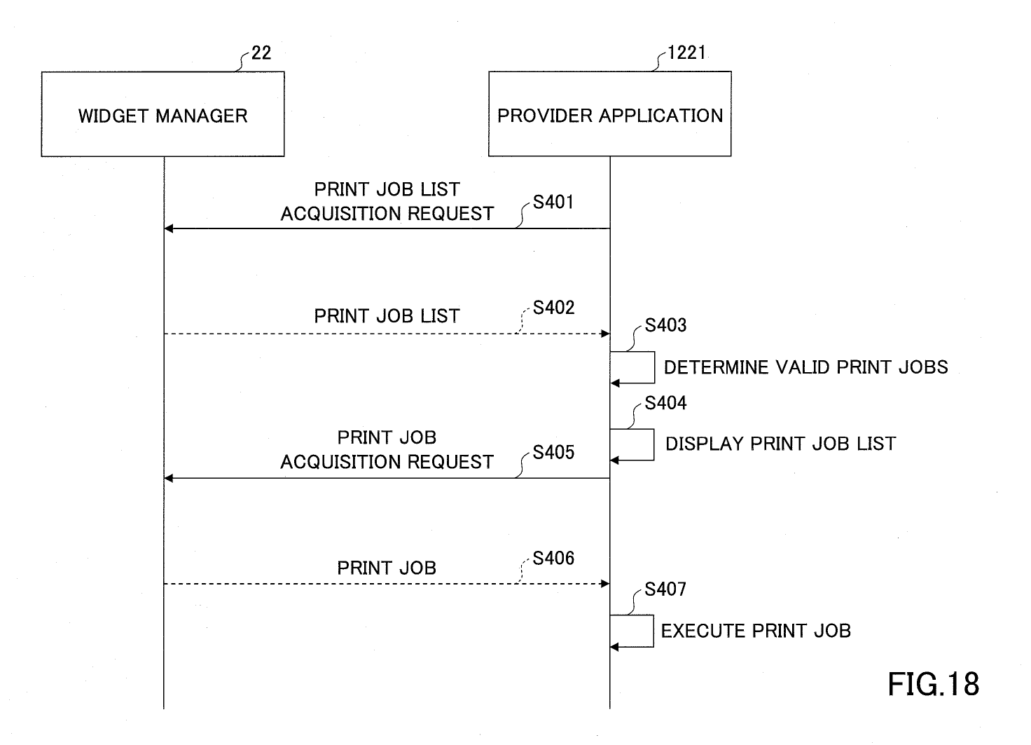

FIG. 18 is a sequence chart illustrating an exemplary process performed when the print widget 21a is selected (or executed).

When the button 621 corresponding to the print widget 21a is selected in step S310 of FIG. 13, the widget linkage unit 135 determines, based on the linked function identifier “print” in the widget information corresponding to the button 621, that a print job is to be executed. Then, the widget linkage unit 135 transmits a print job list acquisition request including a widget URI associated with the widget information to the widget manager 22 corresponding to the widget URI (S401).

The print job list acquisition request is received by the relay unit 224 of the widget manager 22. In response, the relay unit 224 generates a print job list including a print job URI, a job name, and print configuration information for each of print jobs recorded in the secondary storage unit 202 in association with the widget URI specified in the print job list acquisition request, and transmits the print job list to the widget linkage unit 135 (S402). The job name may be, for example, the name of a document file to be printed in the print job.

When the widget linkage unit 135 receives the print job list, the valid widget determining unit 134 determines whether each print job whose print configuration information is included in the print job list is valid in the selected image forming apparatus 10 (S403). More specifically, the valid widget determining unit 134 determines whether a print job is valid by examining combinations of setting names and setting values (i.e., configurations) in the print configuration information with reference to the function validity information stored in the function validity information storing unit 138. If all the combinations of setting names and setting values in the configuration information are valid, the print job is determined to be valid. Meanwhile, if one or more of the combinations of setting names and setting values in the configuration information are invalid, the print job is determined to be invalid.

Here, if there is no print job associated with the widget URI of the print widget 21a selected on the widget selection screen 620 (i.e., if no print job has been entered after the print widget 21a is started), the print job list transmitted in step S402 becomes empty. In this case, the operation performed by the user to select the button 621 corresponding to the print widget 21a on the widget selection screen 620 does not produce any desired result.

To prevent the user from selecting the button 621 in vain, the widget manager 22 may be configured to transmit a print job list for the print widget 21a to the provider application 1221 in step S307 of FIG. 13. In this case, the valid widget determining unit 134 may be configured to determine that the print widget 21a is invalid if the print job list is empty, and the UI control unit 132 may be configured to not display the button 621 corresponding to the print widget 21a for which no print job is entered.

Also in this case, in addition to a process of determining whether the print job list is empty, a process similar to step S403 may be performed in step S308 to determine the validity of print jobs. In this case, the valid widget determining unit 134 may be configured to determine that the print widget 21a is invalid if there is no valid print job. This configuration makes it possible to not display the button 621 corresponding to the print widget 21a for which no print job that is valid in the selected image forming apparatus 10 is entered.

After step S403, the UI control unit 132 displays, on the operations panel 15, a list of job names of print jobs that have been determined to be valid (S404). Accordingly, only the job names of print jobs that can be properly executed on the selected image forming apparatus 10 are displayed. This in turn enables the user to determine whether print jobs can provide desired results before executing the print jobs.

When the user selects one of the job names corresponding to a print job to be executed, the widget linkage unit 135 transmits a print job acquisition request including a print job URI corresponding to the selected job name to the widget manager 22 corresponding to the print job URI (S405).

The print job acquisition request is received by the relay unit 224 of the widget manager 22. In response, the relay unit 224 obtains the print job (print data) stored in the secondary storage unit 202 in association with the print job URI specified in the print job acquisition request and transmits the obtained print job to the widget linkage unit 135 (S406).

When receiving the print job, the widget linkage unit 135 inputs the print job in the function control unit 136. The function control unit 136 requests the print application 1212 to execute the input print job (S407). As a result, an image is printed by the printer 13 on a recording medium (e.g., paper) based on the print data of the print job and the recording medium is output from the printer 13.

Next, an exemplary process performed when the scan widget 21b is selected on the widget selection screen 620 is described.

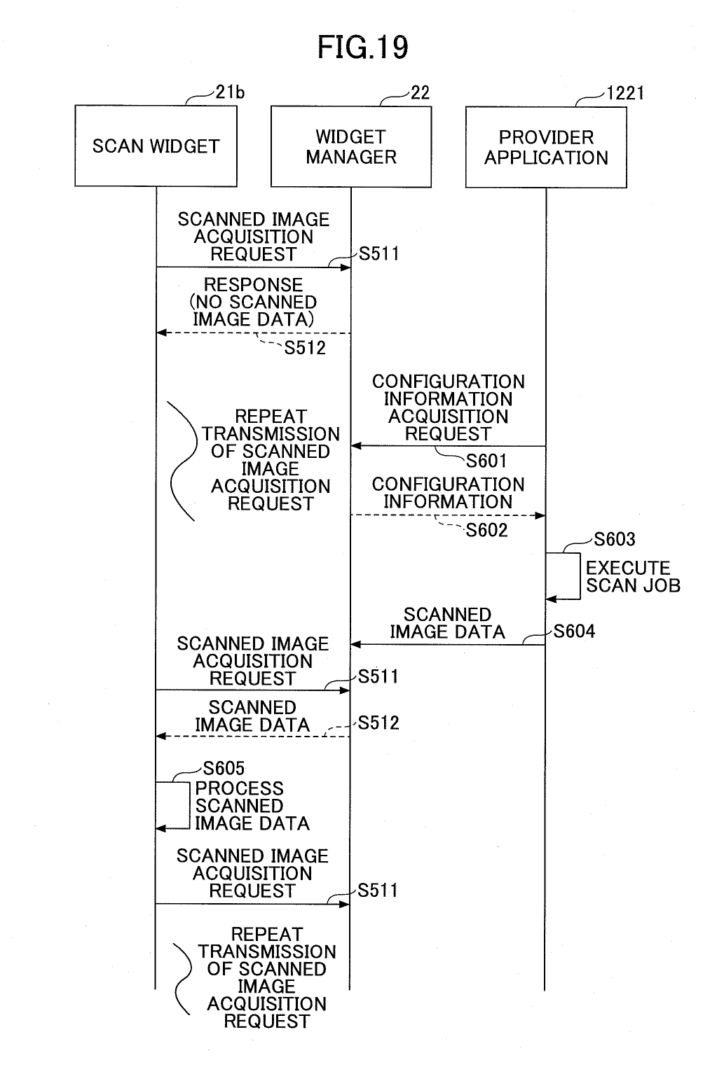

FIG. 19 is a sequence chart illustrating an exemplary process performed when the scan widget 21b is selected (or executed). In this exemplary process, it is assumed that a button corresponding to the scan widget 21b is displayed on the widget selection screen 620.

When a document is set on the image forming apparatus 10 and a button corresponding to the scan widget 21b is selected on the widget selection screen 620 in step S310 of FIG. 13, the widget linkage unit 135 of the provider application 1221 determines that a scan job is to be executed based on the linked function identifier “scan” in the widget information (hereafter called current widget information) corresponding to the selected button. Then, the widget linkage unit 135 transmits a scan configuration information acquisition request including a widget URI associated with the current widget information to the widget manager 22 corresponding to the widget URI (S601).

The scan configuration information acquisition request is received by the relay unit 224 of the widget manager 22. In response, the relay unit 224 transmits, to the widget linkage unit 135, the scan configuration information stored in the secondary storage unit 202 in association with the widget URI specified in the scan configuration information acquisition request (S602). Then, the widget linkage unit 135 inputs the scan configuration information to the function control unit 136.

The function control unit 136 requests the scan application 1211 to execute a scan job based on the scan configuration information (S603). The scan application 1211 causes the scanner 12 to scan the document set on the image forming apparatus 10 to obtain image data (scanned image data) and outputs the scanned image data to the widget linkage unit 135.

Next, the widget linkage unit 135 transmits the scanned image data to the widget URI associated with the current widget information (S604). The scanned image data transmitted to the widget URI are received by the relay unit 224 of the widget manager 22 corresponding to the widget URI.

Meanwhile, after transmitting the widget information, the scan widget 21b performs polling to determine whether scanned image data have been obtained by the image forming apparatus 10 and waits for reception of the scanned image data. More specifically, the linkage unit 213b of the scan widget 21b transmits a scanned image acquisition request for requesting the scanned image data to the relay unit 224 of the widget manager 22 (S511). The relay unit 224 transmits a response to the scanned image acquisition request (S512).

When receiving the scanned image acquisition request (S511) (after receiving the scanned image data), the relay unit 224 transmits the scanned image data associated with the widget URI specified in the scanned image acquisition request to the linkage unit 213b of the scan widget 21b (S512).

When receiving the scanned image data, the linkage unit 213b inputs the scanned image data to the logic unit 214b. The logic unit 214b performs a predefined process (logic) on the scanned image data (S605). More specifically, the logic unit 214b generates a file in a folder specified in the attribute information management file 215b and outputs the scanned image data to the generated file. Then, the linkage unit 213b resumes transmission of the scanned image acquisition request (i.e., resumes polling) in preparation for the next execution of the scan widget 21b (S511) and waits for reception of scanned image data.

As described above, the first embodiment makes it possible to display, on the widget selection screen 620, only widgets 21 that are valid in a selected image forming apparatus 10 being operated by the user. Also, the first embodiment makes it possible to display only print jobs of the print widget 21a that are valid in the selected image forming apparatus 10. Accordingly, the first embodiment makes it possible to prevent, for example, a case where a function or a configuration requested by a widget 21 or a print job turns out to be unavailable (or invalid) in the image forming apparatus 10 after an instruction to execute the widget 21 or the print job is entered, or a case where a configuration requested by the widget 21 is downgraded and a processing result different from what is expected by the user is output. Here, “downgrading” means that a process is performed according to a configuration that is different from a requested configuration. For example, when a document is automatically printed in monochrome on a monochrome image forming apparatus even if color printing of the document is requested, it is called “downgrading”.

A second embodiment is described below. Below, differences between the first and second embodiments are mainly described. Therefore, descriptions in the first embodiment may be applied to components and functions not described below.

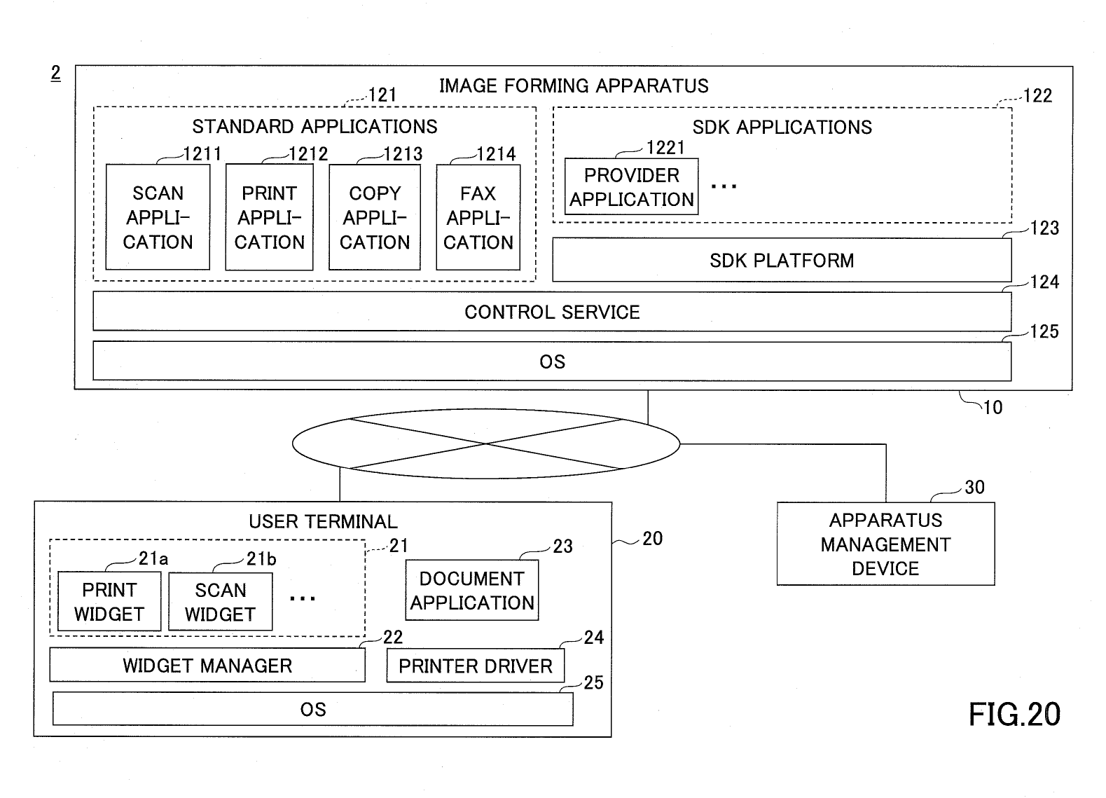

FIG. 20 is a drawing illustrating an exemplary configuration of an information processing system 2 according to the second embodiment. The same reference numbers as in FIG. 1 are assigned to the corresponding components in FIG. 20 and descriptions of those components are omitted here.

As illustrated in FIG. 20, the information processing system 2 additionally includes an apparatus management device 30 connected to the network. The apparatus management device 30 is implemented by, for example, a computer and centrally manages information on the image forming apparatuses 10 connected to the network.

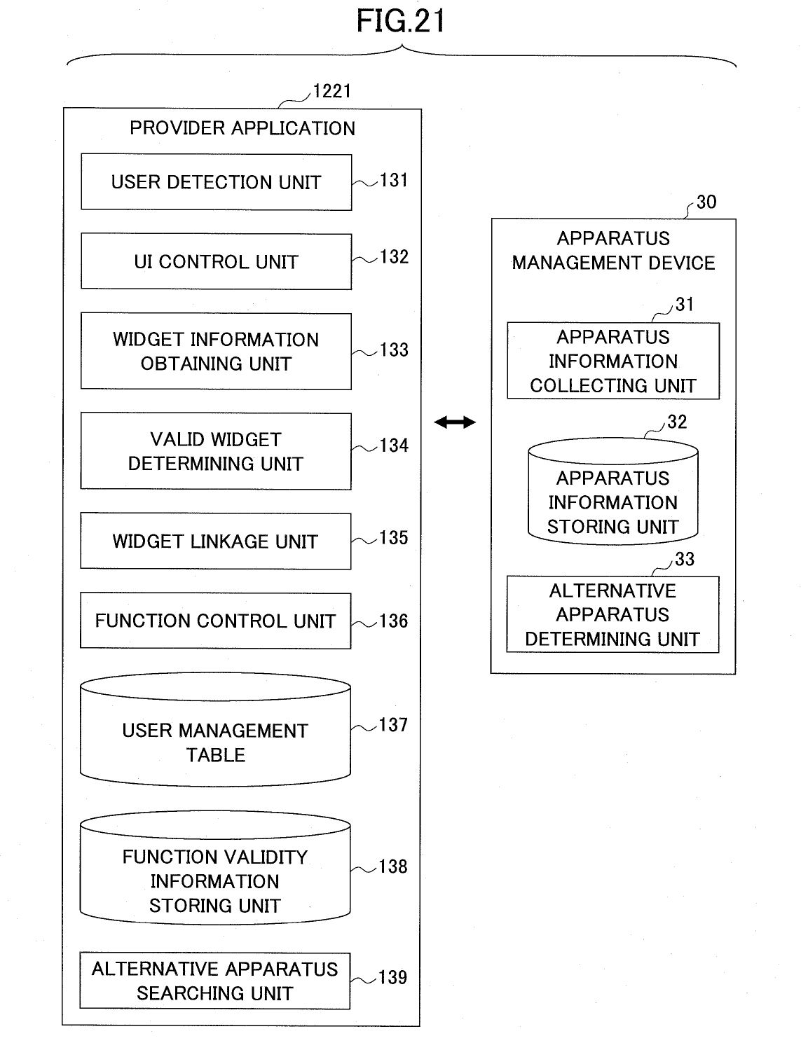

FIG. 21 is a drawing illustrating exemplary functional configurations of the provider application 1221 and the apparatus management device 30 according to the second embodiment. The same reference numbers as in FIG. 4 are assigned to the corresponding components in FIG. 21 and descriptions of those components are omitted here.

As illustrated in FIG. 21, the provider application 1221 of the second embodiment additionally includes an alternative apparatus searching unit 139. When the valid widget determining unit 134 determines that a widget 21 is invalid in the image forming apparatus 10, the alternative apparatus searching unit 139 searches for another image forming apparatus(es) 10 (alternative apparatus(es)) that can satisfy (or support) the function and configuration requested by the widget 21.

The apparatus management device 30 may include an apparatus information collecting unit 31, an apparatus information storing unit 32, and an alternative apparatus determining unit 33 as functional units. These functional units are implemented by executing programs installed in the apparatus management device 30 by a CPU of the apparatus management device 30.

The apparatus information collecting unit 31 collects information (apparatus information) on the image forming apparatuses 10 from the respective image forming apparatuses 10 via the network. The apparatus information may include identification information such as an apparatus name of the corresponding image forming apparatus 10 and information (function validity information) stored in the function validity information storing unit 138 of the image forming apparatus 10. The apparatus information storing unit 32 stores the apparatus information collected by the apparatus information collecting unit 31 in a secondary storage unit (not shown) of the apparatus management device 30. The alternative apparatus determining unit 33 determines an alternative apparatus(es) for a widget 21 specified in a query from the alternative apparatus searching unit 138.

In the second embodiment, in step S309 of FIG. 13, the UI control unit 132, for example, displays a dimmed (or grayed) button for a widget 21 (invalid widget 21) determined to be invalid on the widget selection screen 620. In this case, the dimmed button is selectable. Here, it is not essential to dim a button for an invalid widget 21. For example, a button for an invalid widget 21 may be displayed in the same manner as a button for a valid widget 21.

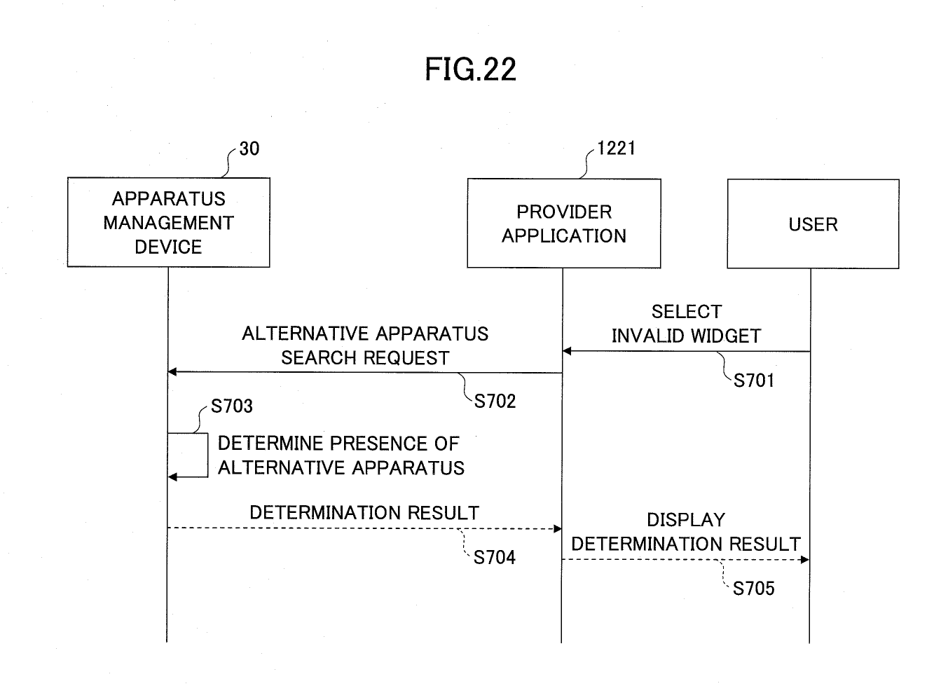

An exemplary process performed when an invalid widget 21 is selected is described below based on the above assumptions. FIG. 22 is a sequence chart illustrating an exemplary process performed when an invalid widget 21 is selected.

In FIG. 22, it is assumed that step S309 of FIG. 13 has been performed and the widget selection screen 620 has been displayed.

In step S701, the user selects a dimmed button (i.e., a button corresponding to a widget 21 that is invalid in the image forming apparatus 10) on the widget selection screen 620. In response, the alternative apparatus searching unit 139 of the provider application 1221 transmits an alternative apparatus search request including the widget information and the configuration information corresponding to the selected button to the alternative apparatus determining unit 33 of the apparatus management device 30 (S702).

When receiving the alternative apparatus search request, the alternative apparatus determining unit 33 determines whether there is an alternative apparatus(es) based on the widget information and the configuration information specified in the alternative apparatus search request and the apparatus information stored in the apparatus information storing unit 32 (S703). The alternative apparatus determining unit 33 may determine whether there is an alternative apparatus(es) through a process similar to the widget validity determination process illustrated in FIG. 17.

Next, the alternative apparatus determining unit 33 returns the determination result to the alternative apparatus searching unit 139 (S704). When at least one alternative apparatus is found, the determination result includes identification information (e.g., an apparatus name) of the found alternative apparatus. If no alternative apparatus is found, the determination result includes information indicating that no alternative apparatus is found).

When the determination result is received by the alternative apparatus searching unit 139, the UI control unit 132 displays information corresponding to the determination result on the operations panel 15 (S705). For example, if no alternative apparatus is found, a message indicating that the selected widget 21 is not executable is displayed. Meanwhile, when at least one alternative apparatus is found, the identification information of the found alternative apparatus and a message indicating that the selected widget 21 is properly executable on the found alternative apparatus are displayed. The user refers to the displayed message, selects the alternative apparatus (i.e., another image forming apparatus 10), and performs operations as illustrated in FIG. 13 on the alternative apparatus to execute the desired widget 21. Since the advertisement is received by all the image forming apparatuses 10 connected to the network, the widget 21 can be executed on any one of the image forming apparatuses 10 that satisfy the function and configuration requested by the widget 21 (i.e., the alternative apparatus).

Alternative apparatuses may be searched for without using the apparatus management device 30. For example, the alternative apparatus searching unit 139 may be configured to request the function validity information from the image forming apparatuses 10 by broadcasting when a dimmed button is selected in step S701. In this case, the alternative apparatus searching unit 139 searches for an alternative apparatus based on the function validity information obtained from the image forming apparatuses 10 and the widget information and the configuration information corresponding to the selected button.

Also, alternative apparatuses may be searched for before the widget selection screen 620 is displayed (i.e., before step S309 is performed). In this case, the UI control unit 132 may display the identification information of a found alternative apparatus(es) above or next to (or in association with) the button corresponding to an invalid widget 21 on the widget selection screen 620. This makes it possible to eliminate the need for the user to select the button corresponding to the invalid widget 21. Thus, information on alternative apparatuses may be displayed before a button corresponding to an invalid widget 21 is selected.

Alternative apparatuses may also be searched for when a print job is invalid. For example, alternative apparatuses for invalid print jobs may be searched for before or after a list of job names of print jobs is displayed in step S404 of FIG. 18.

An aspect of this disclosure provides an image forming apparatus, an information processing method, and a storage medium that make it possible to reduce the workload of a user in operating programs that perform processes in collaboration with image forming apparatuses via a network.

The present invention is not limited to the specifically disclosed embodiments, and variations and modifications may be made without departing from the scope of the present invention.

What is claimed is:

1. An image forming apparatus, comprising:
a function validity information storing unit configured to store function validity information including identification information of functions available in the image forming apparatus and configurations of the functions that are valid in the image forming apparatus;
a receiving unit configured to receive identification information of requested functions to be executed on the image forming apparatus and configuration information of the requested functions from a computer connected via a network to the image forming apparatus;
a determining unit configured to determine whether the requested functions are valid by examining the identification information and the configuration information of the requested functions with reference to the function validity information stored in the function validity information storing unit; and
a display control unit configured to display, on a display unit, an option corresponding to a valid function of the requested functions that is determined to be valid such that the option corresponding to the valid function is distinguishable from an option corresponding to an invalid function of the requested functions that is determined to be invalid.

2. The image forming apparatus as claimed in claim 1, further comprising:
a searching unit configured to search for an alternative image forming apparatus that supports the invalid function and the configuration information of the invalid function,
wherein the display control unit is configured to display, on the display unit, identification information of the alternative image forming apparatus found by the searching unit in association with the option corresponding to the invalid function.

3. The image forming apparatus as claimed in claim 1, wherein the display control unit is configured to dim the option corresponding to the invalid function.

4. The image forming apparatus as claimed in claim 1, wherein the display control unit is configured to not display the option corresponding to the invalid function on the display unit.

5. A method performed by an image forming apparatus,
the image forming apparatus storing function validity information including identification information of functions available in the image forming apparatus and configurations of the functions that are valid in the image forming apparatus,
the method comprising:
receiving identification information of requested functions to be executed on the image forming apparatus and configuration information of the requested functions from a computer connected via a network to the image forming apparatus;
determining whether the requested functions are valid by examining the identification information and the configuration information of the requested functions with reference to the function validity information; and
displaying, on a display unit, an option corresponding to a valid function of the requested functions that is determined to be valid such that the option corresponding to the valid function is distinguishable from an option corresponding to an invalid function of the requested functions that is determined to be invalid.

6. The method as claimed in claim 5, further comprising:
searching for an alternative image forming apparatus that supports the invalid function and the configuration information of the invalid function,
wherein identification information of the alternative image forming apparatus found in the searching step is displayed on the display unit in association with the option corresponding to the invalid function.

7. The method as claimed in claim 5, wherein the option corresponding to the invalid function is dimmed.

8. The method as claimed in claim 5, wherein the option corresponding to the invalid function is not displayed on the display unit.

9. A non-transitory computer-readable storage medium storing program code for causing an image forming apparatus to perform a method,
the image forming apparatus storing function validity information including identification information of functions available in the image forming apparatus and configurations of the functions that are valid in the image forming apparatus,
the method comprising:
receiving identification information of requested functions to be executed on the image forming apparatus and configuration information of the requested functions from a computer connected via a network to the image forming apparatus;
determining whether the requested functions are valid by examining the identification information and the configuration information of the requested functions with reference to the function validity information; and
displaying, on a display unit, an option corresponding to a valid function of the requested functions that is determined to be valid such that the option corresponding to the valid function is distinguishable from an option corresponding to an invalid function of the requested functions that is determined to be invalid.

10. The storage medium as claimed in claim 9, the method further comprising:
searching for an alternative image forming apparatus that supports the invalid function and the configuration information of the invalid function,
wherein identification information of the alternative image forming apparatus found in the searching step is displayed on the display unit in association with the option corresponding to the invalid function.

11. The storage medium as claimed in claim 9, wherein the option corresponding to the invalid function is dimmed.

12. The storage medium as claimed in claim 9, wherein the option corresponding to the invalid function is not displayed on the display unit.
